(19) United States
(12) Patent Application Publication
(10) Pub. No.: US 2005/0015316 A1
(43) Pub. Date: Jan. 20, 2005

(54) Methods for calendaring, tracking, and expense reporting, and devices and systems employing same

(76) Inventor: Vincenzo Salluzzo, Amsterdam, NY (US)

Correspondence Address: HESLIN ROTHENBERG FARLEY & MESITI PC, 5 COLUMBIA CIRCLE, ALBANY, NY, 12203, US

(21) Appl. No.: 10/612,689

(22) Filed: Jul. 2, 2003

(51) Int. Cl. G06F 17/60

(52) U.S. Cl. 705/30

(57) ABSTRACT

A computerized integrated method for determining expenses related to travel includes storing a plurality of appointments at a plurality of different locations, tracking a physical location of a user in realtime to the plurality of appointments, and automatically assigning expenses to least one of the plurality of appointments based on the tracking of the physical location of the user to the plurality of different locations. For example, mileage expenses, credit card purchase expenses, and airplane, train and hotel expenses, may be automatically linked and assigned to the particular appointment. The method may be incorporated in handheld devices such as personal digital assistants. The method may also be provided as a subscription service to businesses and leisure travelers.

### FIELD OF THE INVENTION

This invention relates generally to expense reporting, and more particularly, to integrated calendaring, tracking, and expense reporting methods, devices, and systems for business personnel and leisure travelers.

### BACKGROUND OF THE INVENTION

Business personnel often meet with many customers at different locations throughout a day or over a period of time. This requires scheduling the various appointment times and locations. In addition, business personnel are required to record and report expenses associated with appointments with the various customers. Expenses typically include expenses related to automobile transportation, tolls, air or train transportation, meals, entertainment, etc.

Often, when completing expense reports, business personnel may inadvertently fail to accurately record and report all the expenses incurred. In addition, there is the possibility of business personnel intentionally including expenses that were not, in fact, incurred.

There is a need for an integrated calendaring, tracking, and expense reporting methods, devices, and systems for business personnel and leisure travelers.

### SUMMARY OF THE INVENTION

In a first aspect, the present invention provides a computerized method for determining expenses related to travel which includes storing a plurality of appointments at a plurality of different locations, tracking a physical location of a user in realtime to the plurality of appointments, and automatically assigning expenses to at least one of the plurality of appointments based on the tracking of the physical location of the user to the plurality of different locations.

In a second aspect, the present invention provides a computerized method for determining expenses related to travel which includes storing a plurality of appointments at a plurality of different locations, tracking a physical location of a user in realtime to the plurality of appointments, automatically assigning expenses to least one of the plurality of appointments based on the tracking of the physical location of the user to the plurality of different locations, automatically assigning expenses regarding at least one of an airplane ticket and a train ticket to at least one of the plurality of appointments, automatically assigning expenses regarding a purchase to at least one of the plurality of appointments, and at least one of displaying and printing a report of the plurality of appointments and the expenses associated with the plurality of appointments.

In a third aspect, the present invention provides a computerized method for assisting a traveler which includes storing a plurality of contact profiles comprising at least a name and a location of the contact, storing a plurality of appointments at a plurality of different locations, the storing comprising automatically assigning at least one location of the contact as the location of the appointment, tracking a physical location of a user in realtime to the plurality of appointments, automatically assigning expenses to at least one of the plurality of appointments based on the tracking of the physical location of the user to the plurality of different locations, storing at least one note and document relating to at least one of the appointments, notifying the user of at least one of a message and a warning, and providing information to the user relating to the physical location of the user.

Other aspects of the invention include portable electronic devices, systems, services, and computer program products which incorporate the above-described methods.

### BRIEF DESCRIPTION OF THE DRAWINGS

The subject matter which is regarded as the invention is particularly pointed out and distinctly claimed in the concluding portion of the specification. The invention, however, may best be understood by reference to the following detailed description of various embodiments and the accompanying drawings in which:

FIG. 1 is a diagrammatical illustration of one embodiment of an integrated calendaring, tracking, and expense reporting system in accordance with the present invention;

FIG. 2 is a block diagram of a handheld device of the system of FIG. 1;

FIG. 3 is a block diagram of the central computing unit of the system of FIG. 1;

FIG. 4 is a block diagram of the various components of the system of FIG. 1;

FIG. 5 is a main menu screen of the handheld device of FIG. 1;

FIG. 6 is an appointments screen which is accessed by touching the TODAY's APPT button of FIG. 5;

FIG. 7 is a contact profiles screen which is accessed by touching the CONTACT PROFILES button of FIG. 5;

FIG. 8 is a flowchart of a method for linking expenses to the calendar appointments in accordance with the present invention;

FIG. 9 is another flowchart of a method for linking expenses to the calendar appointments in accordance with the present invention;

FIG. 10 is an appointment expenses screen accessed by touching one of the EXPENSES button of FIG. 6;

FIG. 11 is an expenses screen accessed by touching the EXPENSES button of FIG. 5;

FIG. 12 is a printout of an expense report for a day which is accessed by touching the DAILEY EXPENSES button of FIG. 11;

FIG. 13 is a printout of an expense report for a week which is accessed by touching the WEEKLY EXPENSES button of FIG. 11;

FIG. 14 is another embodiment of an appointments screen which is accessed by touching the TODAY's APPT button of FIG. 5;

FIG. 15 is a notes screen which is accessed by touching the NOTES button of FIG. 5;

FIG. 16 is a filing cabinet screen which is accessed by touching the FILING CABINET button of FIG. 5;

FIG. 17 is a message screen which is accessed by touching the MESSAGE button of FIG. 5;

FIG. 18 is an inquiry screen which is accessed by touching the INQUIRY button of FIG. 5; and

FIG. 19 is an alert screen which is accessed by touching the ALERT button of FIG. 5.

### DETAILED DESCRIPTION OF THE INVENTION

The present invention, in accordance with one embodiment, provides an integrated and computerized travel assistant which may integrate realtime global positioning navigation and tracking capabilities, calendar-based automatic travel planning capabilities, expense reporting capabilities, and geographic-based, dynamic advertising capabilities, as described in greater detail below.

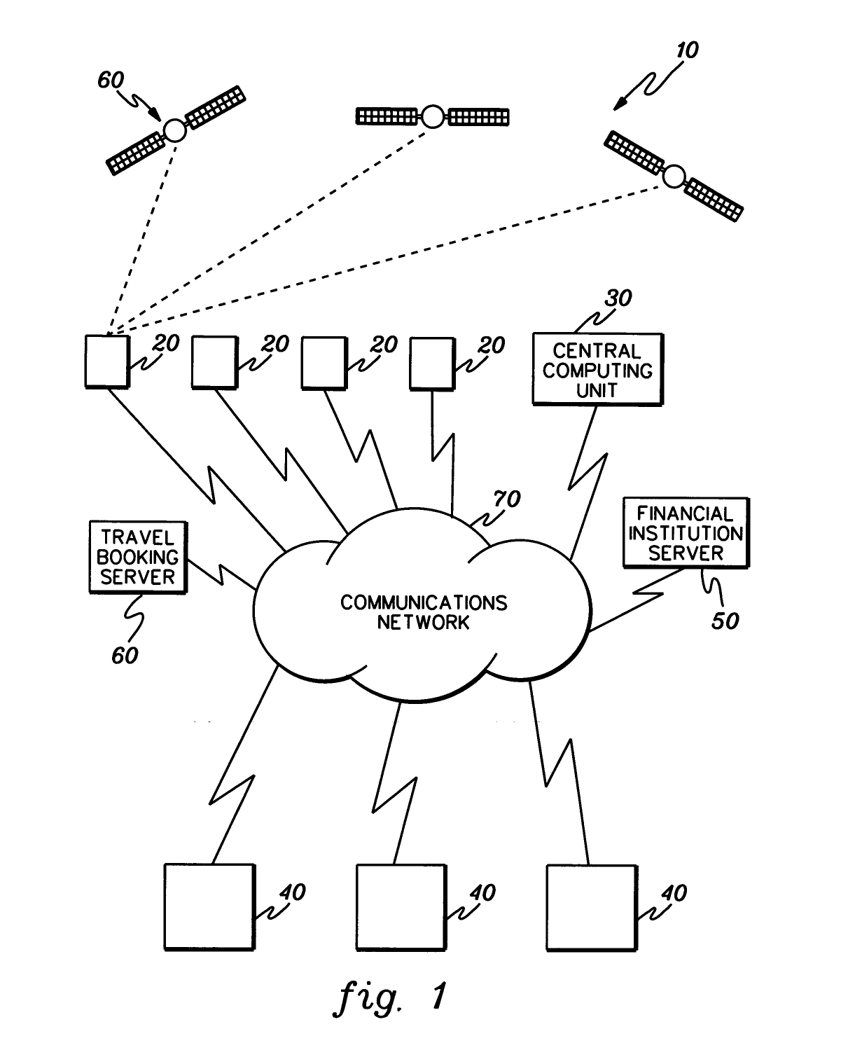

FIG. 1 illustrates one example of an integrated and computerized travel assistant system 10 for calendaring, tracking, and expense reporting in accordance with the present invention. System 10 may include a plurality of handheld devices 20 such as PDAs (personal digital assistants) having position locating capabilities, a central computing unit or server 30, a plurality of computers 40 such as different corporate business computers or servers, one or more financial institutions 50 such as credit card issuers and banks, and one or more travel booking servers 60 such as airline computer servers or the SABRE travel network. The various components may be linked to each other via a communications network 70 such as a telephone network, telephone cell network, satellite phone network, a global communications network such as the Internet, other communications networks, or combinations thereof. The plurality of handheld devices 20 may be operable to receive data to determine the physical location of the handheld device from a position locating system 80 such as a global positioning system (GPS).

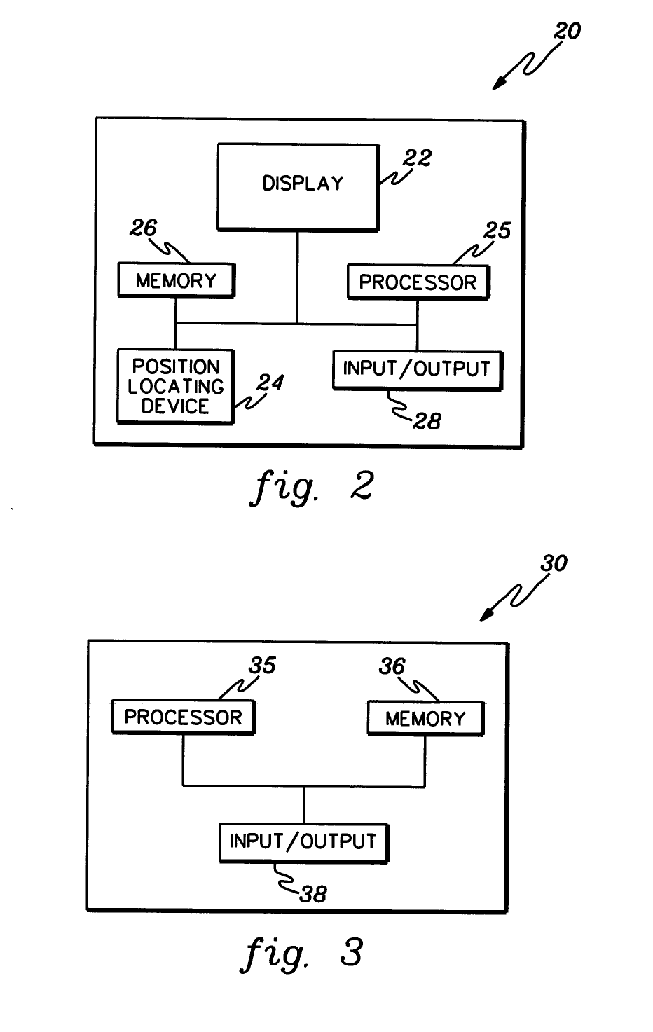

FIG. 2 is a block diagram of one of the handheld devices 20, which may include a display screen 22 such as a touch screen display, a position locating device 24 such as a GPS receiver, a processor or microcontroller 25, a memory or data storage unit 26, and at least one input/output device 28 such as a wireless transmitter and/or keyboard. FIG. 3 is a block diagram of central computing unit 30, which may include a processor 35, a memory or data storage unit 36, and at least one input/output device 88 such as a display screen or monitor and/or a keyboard.

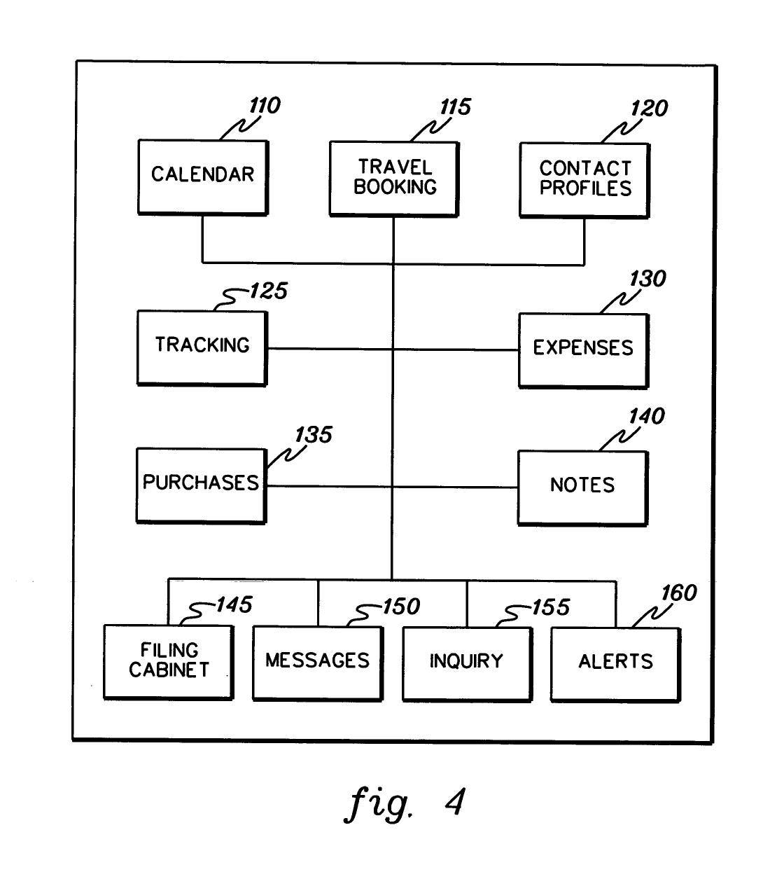

FIG. 4 illustrates a block diagram of the various integrated component applications, e.g., software and/or hardware, of system 10 which may include a calendar 110, travel booking 115, contact profiles 120, tracking 125, expenses 130, purchases 135, notes 140, filing cabinet 145, messages 150, inquiry 155, and alerts 160. From the description below, the components may be incorporated and disposed in a handheld device, a central computing unit, a business computer, or in a combination thereof.

Briefly, the various components are described as follows. Calendar 110 allows a user to set up and schedule dates and times, contact persons, and locations of appointments. The calendar may access a map database to provide driving directions and maps from appointment to appointment based on user-entered appointments. Travel booking 115 may also allow a user to schedule and book transportation such as airline flights or trains, hotels, rental cars, and other items.

Contact profiles 120 allows a user to create, edit, and search a database of contact names, addresses, phone numbers, email addresses, and other pertinent data. The contact profiles may also allow a user to select a preferred method of travel (which may override an automatically selected mode of transportation as described in greater detail below).

Tracking 125 receives data from the position locating device to provide a realtime and continuous tracking of the physical location of the handheld device, and thus, of the user. The tracking component also allows recording of actual miles traveled, travel routes taken, and time spent at locations by a user. The tracking component may have access to or include a map database.

Expenses 130 automatically determines and/or receives expenses, records expenses, and updates expenses to the appropriate appointment accounts based on tracking of the user to the various travel arrangements. The expenses component may also include or have access to a database for obtaining expenses for tolls for thoroughfares, bridges and tunnels. The expenses component may also generate expense reports which may be based on the contact person, or based on expenses which occurred over a day, a week, a month, and/or a year. Purchases 135 links purchases such as credit card charges, ATM or bank withdrawals, checks and other charges to the appropriate expense accounts.

Notes 140 allows a user to store notes regarding particular appointments. Filing cabinet 145 allows a user to store documents and other information. Messages 150 allows a user to retrieve or access telephone, email, and other messages.

Inquiry 155 provides a user with region-specific information, for example, relevant databases such as the yellow pages (e.g., listings of businesses and professional firms alphabetically by category) or information from the Internet based on the user's location as determined by tracking module 125. The region specific information module may also use push technology to direct information to the user based on the user's location.

Alert 160 may allow for alerting the user to urgent messages by authorized persons, changes in airline flights or train schedules, traffic delays, etc.

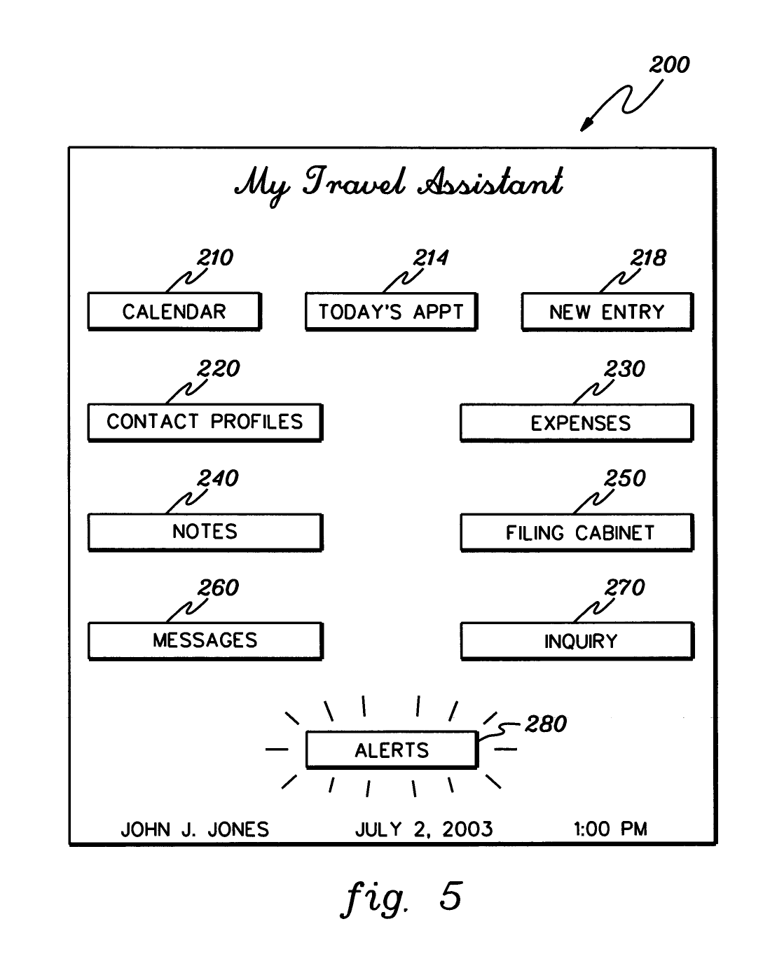

FIGS. 5-7 and 10-19 illustrate one example of screens or displays which may be presented to a user on handheld device 20 (FIG. 1) for implementing the travel assistant capabilities in accordance with the present invention.

FIG. 5 illustrates a main menu screen 200, for example a touch screen display, which displays various categories or options for access by a user. For example, main menu screen 200 may include a CALENDER button 210, a TODAY's APPT button 214, a NEW ENTRY button 218, a CONTACT PROFILES button 220, an EXPENSES button 230, a NOTES button 240, a FILING CABINET button 250, a MESSAGES button 260, an INQUIRY button 270, and an ALERTS button 280, as described in greater detail below.

It will be appreciated that while a touch screen display is described, other displays and input devices would also be suitable. In addition, while reference is made to touching the screen or touching various buttons displayed on the screen to bring up another screen, it will be appreciated that the various displayed information may be hyperlinked. Also, the various displayed items and sub items may be configured as dropdown menus, which allow the user a choice of screen displays. Thus, the present invention should neither be limited to the particular screen configurations nor be limited to the way in which the screens are linked together. In addition, the screen displays may be stored on the handheld device, may be retrievable via the communications network from the central computer or business computer, and may be retrievable using a browser which accesses the screen displays via the communications network such as the World Wide Web from a central computer or a business computer.

Touching CALENDER button 210 may result in a display of a plurality of blocks (not shown) which correspond to a number of days such as the upcoming days in a week, two-weeks, or the current month. Suitable buttons or links may be provided for displaying future or prior days, weeks, months, or years. The user may touch one of the blocks or days to bring up a display of the calendar appointments for that particular day as explained in greater detail below.

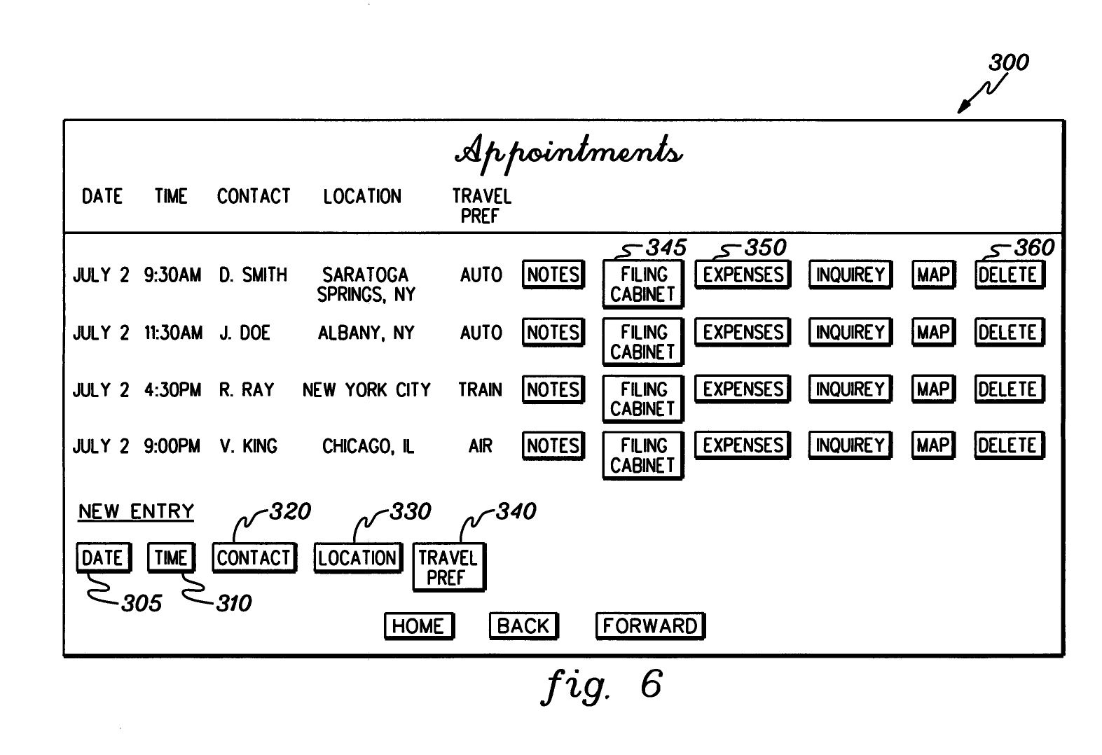

Touching TODAY's APPT button 214 results in an appointments screen display 300 for the current day as shown in FIG. 6. The screen may include the date, time, contact, location, and travel preferences for the appointments. The various items for each appointment may be accessed by touching the various item, e.g., the various items in the appointments may be hyperlinked. For example, editing an entry may be made by respectively touching the date to bring up a calendar display, touching the time to access a clock display, touching the contact to access the contact profiles display (described in greater detail below), touching the location of the meeting to override the location for the appointment (e.g., if the appointment is change to a restaurant and not the contact's normal place of business), and touching the travel preference to override the travel preference (described in greater detail below). Buttons may also be included for entering notes for discussion at the appointment or taking notes during the appointment, accessing a filing cabinet for retrieving and adding documents (FILING CABINET buttons 345), accessing expense reports regarding the appointments (EXPENSES buttons 350), and deleting an appointment (DELETE buttons 360).

Touching a MAP button may retrieve a map to the location of the corresponding appointment, provide a list of directions from the previous appointment and/or current location to the appointment location, and/or display a map illustrating the directions from the current location to the appointment. For example, upon touching a MAP button, the handheld device may determine the user's location based on data from the position locating device, the location is then transmitted to the central computing unit via, for example, initially over a cell phone connection. The central computing unit then may transmit a map and/or directions back to the handheld device via, e.g., the cell phone connection, wireless network, or satellite, for display. A map database may also be stored in the handheld device, thereby reducing the need to transmit and receive information from the central computing unit in order to retrieve a map and/or directions. The handheld device may be connectable to a printer, and the display of the map and/or directions (for example, directions sequentially from one appointment to the next during the day) may be printed out. The routing location may be from the user's residence address, or a location based on the prior days appointments where the user is out of town such as at a hotel or at an airport. The map feature reduces the likelihood of the user getting lost even for short periods of time, or not taking shortest route to a destination, thereby reducing the loss of valuable time and costs. When requested, the map and routing to the next scheduled appointment may occur automatically from the user's then current location. Should the user require directions to a point other than from his current location (for example, to provide another person with directions), the user may acquire any point-to-point directions via the INQUIRY button described below.

For example, touching NEW ENTRY button 218 may result in a display of a plurality of blocks (not shown) which correspond to the upcoming days such as a week, two-weeks, or the current month. The user may then touch one of the blocks or days to bring up the calendar appointments for that particular day for the new entry. As described above, suitable buttons or links may be provided for advancing the display of the day(s) to future weeks or months which are initially not shown on the display. After touching the NEW ENTRY button, the user may have the option of simply entering a future date (e.g., Apr. 19, 2005) which then displays the appointment calendar for that date allowing appointments to be entered, as described below.

Once a particular future day is selected, the appointments scheduled for that day are displayed in the top half of the screen such as shown in FIG. 6. At the bottom of the appointments screen is a section for entering and editing a new appointment, the time, the contact person, and the location of the appointment. Touching a TIME button 310 may bring up a display of a clock for selecting the time of the appointment. Touching a CONTACT button 320 may bring up a contacts profile display 400 (as described in greater detail below) from which the user can retrieve an existing contact profile or add a new contact profile. Touching a LOCATION button 330 allows changing the location of the appointment from the client's normal business location and touching a TRAVEL PREFERENCE button 340 allows overriding the automatically selected travel mode as described in greater detail below.

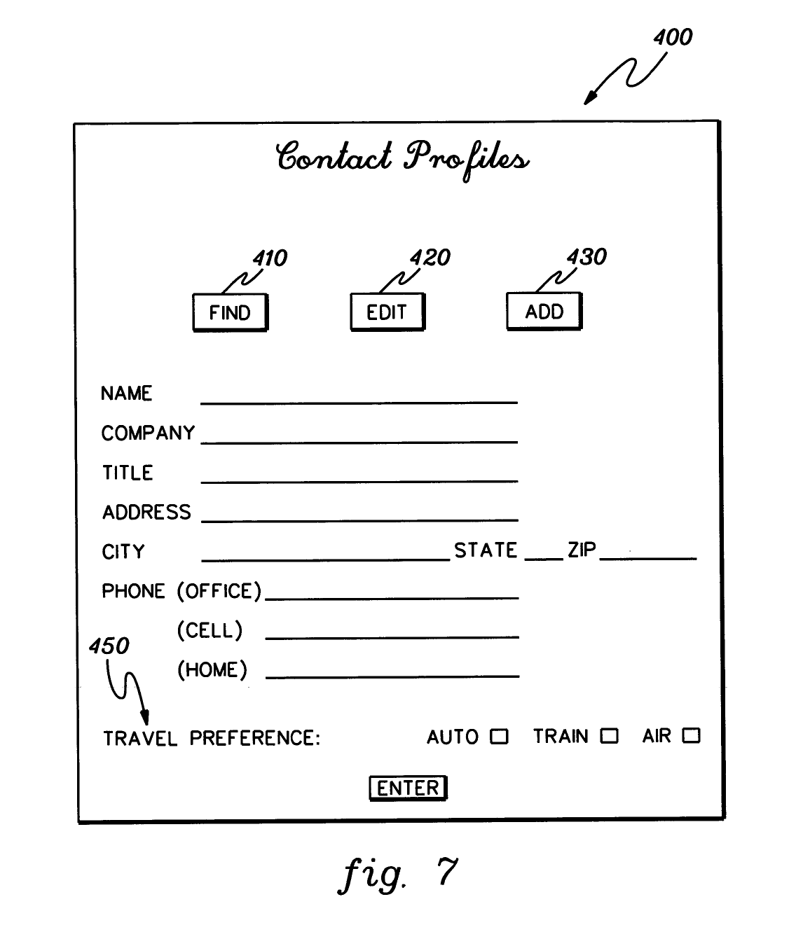

With reference again to FIG. 5, touching CONTACT PROFILES button 220 retrieves and displays contact profile screen 400 as shown in FIG. 7. Contact profiles screen allows retrieving, editing, and adding contact profiles. Contact profiles may include data regarding the name, the company, the address, the phone number, the email address, etc. of the contact. For example, a FIND button 410, an EDIT button 420, and an ADD button 430 may be provided to allow the user to access currently stored contact profiles, edit stored contact profiles, and add new contact profiles, respectively. Touching FIND button 410 or EDIT button 420 may bring up a screen which lists the letters of the alphabet or allows the user to scroll through currently stored contact names. ADD button 430 may be touched to enter a mode where the user can enter the various contact information in the locations noted on the screen. A Travel Preference Section 450 may be provided for allowing a user to enter a travel preference irrespective of a driving mileage parameter and rail exception as described in greater detail below. Data regarding the user's contact profiles may be stored on the handheld device or may be transmitted and stored at a remote location such as at the central computing unit or the business computer, or both. In addition to the user, others such as the user's assistant, or other authorized persons may have access to the contact profile database for adding or updating the contact profiles database.

In addition, the handheld device may include a scanner for scanning in a contact's business card or a magnetic card reader for reading a magnetic strip on the contact's business card. For example, business cards may include a bar code or magnetic strip which provides the contacts profile such as name, company, address, phone number email address, etc. of the contact which is automatically added to the contact profile database by scanning or reading the business card using the handheld device.

With reference again to FIG. 4, calendar module 110 may be operable, e.g., to provide a set-up screen for the user, which allows a user to establish a driving mileage parameter corresponding to the distance in miles that the user will normally travel to an appointment, for example, from the users home. In addition, a user may also establish rail exceptions, which may comprise areas (e.g., based on zip codes) within the driving mileage parameter that a user would normally travel to an appointment by train. For example, if a user normally uses rail transportation to a given location, such as from Albany, N.Y. to New York City, the user may program that information as a rail exception.

With reference again to FIG. 6, upon entering an appointment in the calendar, the user may be presented with travel accommodations based on driving mileage parameter and the rail exceptions unless the contact profiles include a preferred mode of travel. If the contact is within the driving mileage parameter, and not in the rail exceptions, the system will automatically indicate the mode of travel (e.g., auto) and the MAP button will provide routing from the user's then current location to the contact location for that appointment.

If the contact is within the driving mileage parameter, but in a zip code designated as a rail exception, “TRAIN” will be displayed for that appointment and touching on “TRAIN” will bring up a railway or train schedules for that date. If an appointment is located outside the driving mileage parameter and user-specified rail exceptions (e.g., user is located in New York and the contact person's location is Chicago), “AIR” will be displayed for that appointment and touching on “AIR” will provide flights (e.g., from New York to Chicago), hotel information (in Chicago), and rental car information.

The user may select and reserve flights, hotel rooms and rental cars. For example, a drop down screen of each hotel's location relative to the contact person's address entered in the calendar appointment may be displayed. In addition, prior bookings, e.g., previously selected hotel preferences may be automatically presented. Packaged travel arrangements having the least cost, or fastest travel time, may also be presented to the user. Booking may occur automatically upon the user confirming the arrangements using a single keystroke or click of a mouse. In addition, the user may query and tailor a different set of travel options and arrangements, for example, query for hotel selections over a wider geographic area. For example, the user may be presented with a map of a larger geographic area, and hotels may be displayed on the map for selection by the user.

The entire travel itinerary may be automatically arranged, reserved, confirmed, paid for, properly accounted, organized in various convenient formats, and linked to relevant dates in the user's calendar appointments. A confirmation number may be provided back to the user's account automatically.

Upon arrival in a city that has alternate means of transportation, i.e. subway or trolley, a user (e.g., may touch the MAP button) and be presented with subway (or trolley) route to a scheduled appointment. Appropriate directions to subway entrance, and appropriate routing while on subway and from subway exit to the contact person's address may be presented in realtime on handheld device.

If an appointment has been entered in the user's calendar for the following day in a different city, and no hotel is selected, flight information to the next location will be presented to the user. If the user has not entered another appointment for the following day in another location, flight schedules to original departure airport may be presented to the user.

The system may automatically alert the user of the need to modify travel itineraries, such as canceling or adding flights, based on newly added or deleted calendar entries. Should the user have to cancel an appointment, the user may do so by touching one of the DELETE buttons 360. The travel arrangements may be canceled immediately, and if provided, the user or the business may be charged a nominal cancellation fee or no fee if the user is a member of a subscription service as described below. The system may compare the relationship of dates and locations and may alert or warn a user of problems or conflicts and request correction. For example, if a user schedules an appointment in Chicago, Ill. on a date and books a return flight on the next day to Albany, N.Y., and later schedules an appointment in Dallas, Tex. on the return date, the system may compare these dates and anticipated locations and alert user of the conflict. The system may notify the user of possible suggestions for traveling from Chicago to Dallas.

Credit card transactions may be automatically linked to the appropriate calendar appointments based on the user's credit card number and the location (e.g., geographic coordinates) or the time of purchase when the credit card was approved or used. The system may be operably connected to various financial institutions for handling purchases such as credit cards, debit cards, checks, etc. and those transactions may be similarly linked to the express and calendar components.

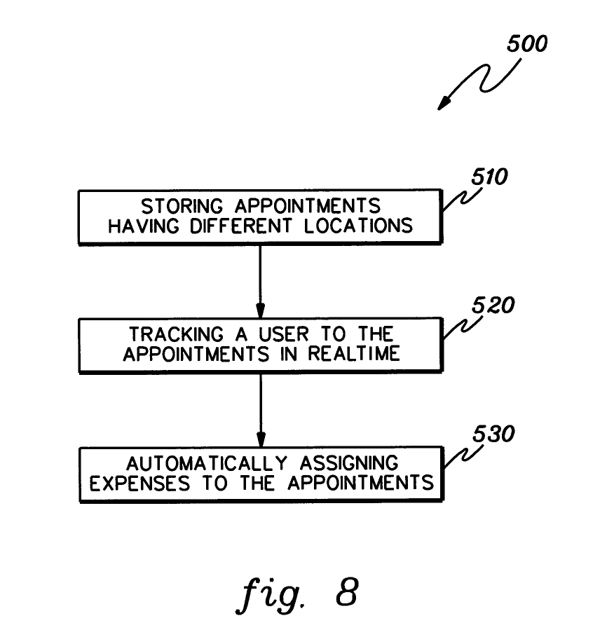

FIG. 8 illustrates an example of a method 500 for linking the expenses to a calendar appointment entry. Method 500 includes the steps of storing appointments having different locations at 510, tracking in realtime the physical location of the user to the plurality of appointments at the different locations at 520, and automatically assigning expenses to the various appointments based on the tracking of the physical location of the user to the different locations.

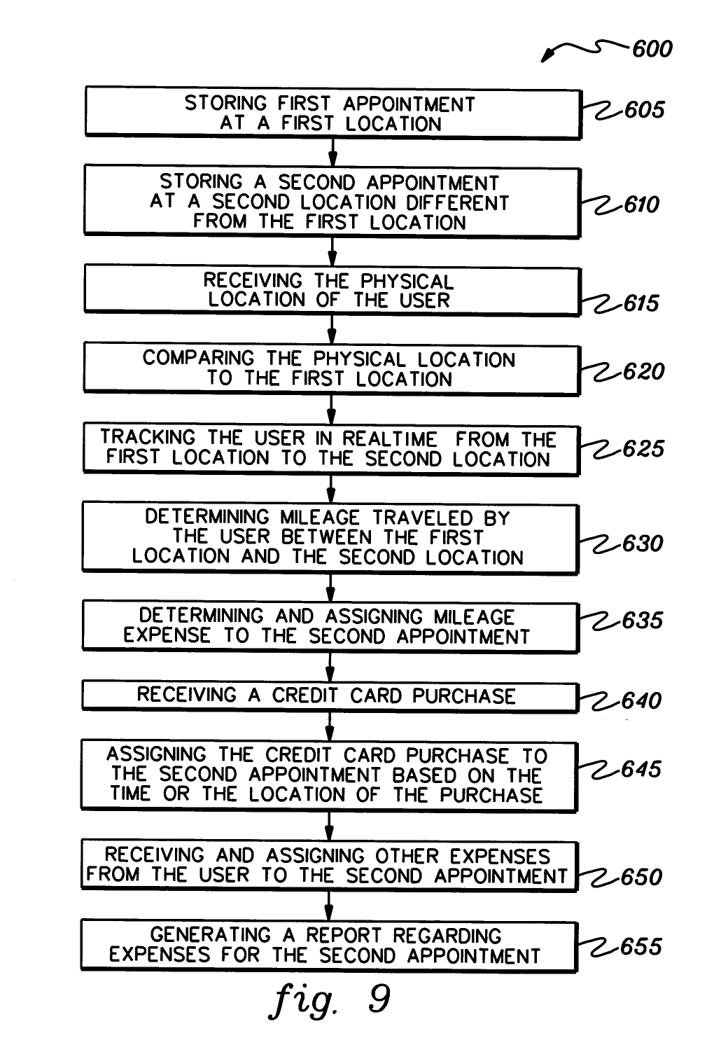

FIG. 9 illustrates an example of another method 600 for automatically linking the expenses to a calendar appointment entry wherein the mode of travel is by automobile. The method may include at 605, storing a first appointment at a first location which may be inputted by the user, and storing a second appointment at a second location which may be inputted by the user at 610 and which is different from the first location. At 615, receiving the physical location of the user may be provided by the position locating device in the handheld device.

The physical location of the user is compared to the first location at 620 and the user is tracked in realtime to the second location at 625. The mileage between the first location and the second location is determined at 630 based on the tracking of the user, and a mileage expenses is determined and assigned, e.g., 36 cents per mile, to the second appointment at 635. A database of tolls for toll roads, bridges and tunnels may be provided and/or accessable by the system, and based on the tracking of the user via GPS, the appropriate tolls may also be recorded, and properly expensed.

Further expenses may be assigned to the second appointment. For example, at 640, credit card purchases may be received by the system, and at 645, assigned to the second appointment based on the location of the purchase or the time of the purchase. For example, if the appointment occurred at 12:30 PM at a restaurant, and a charge was made on the credit card at 1:45 PM, the system will annotate the expense automatically or upon the user touching the EXPENSE button on the appointments calendar shown in FIG. 6.

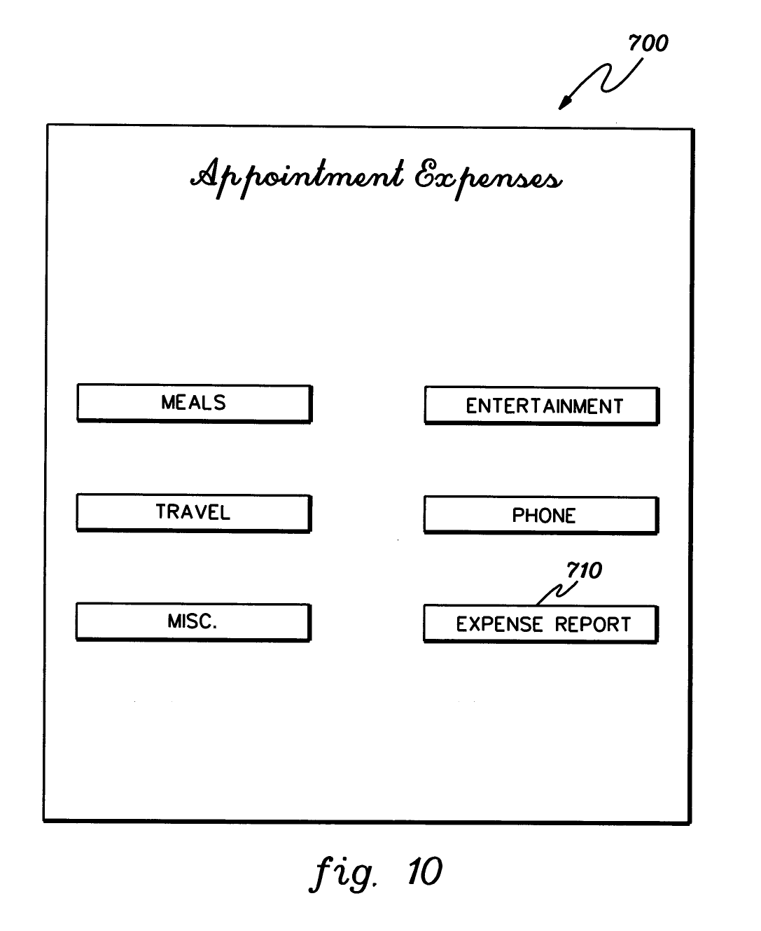

At 650, other expenses may be manually inputted by the user and assigned to the appointment. For example, with reference again to FIG. 6, touching the EXPENSES button accesses an appointment expenses screen 700, as shown in FIG. 10, for allowing the user to manually enter other expenses for the appointment by touching one of the various MEALS, ENTERTAINMENT, TRAVEL (such as taxi cab or subway costs, parking), PHONE, and MISCELLANEOUS buttons, e.g., when cash is used in the transaction. It will be appreciated that other categories of expense may be provided.

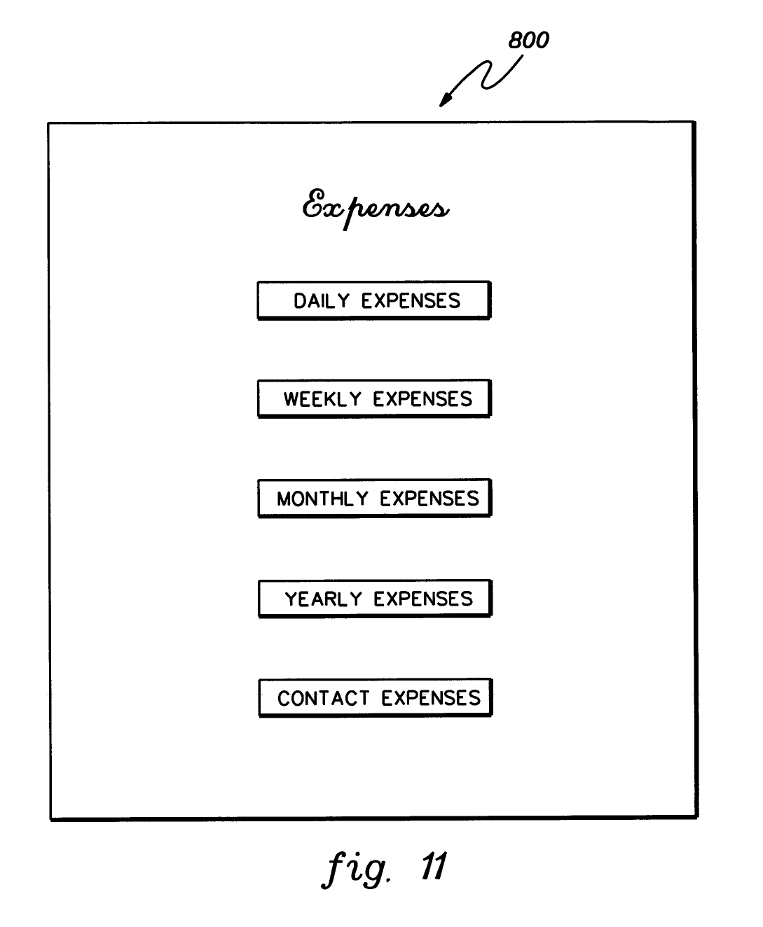

With reference again to FIG. 9, reports may be generated at 655, for the appointment (e.g., accessed by the screen in FIG. 10 by touching EXPENSE REPORT button 710), or touching EXPENSES button 230 (FIG. 5) of the main menu screen 200 (FIG. 5) to display an expense screen 800 as shown in FIG. 11 for accessing expense reports over a week, month, or year, or, expenses relating to a contact. It will be appreciated that the system may be configured so that touching the EXPENSES button in FIG. 6 results in a display of the expenses for that appointment.

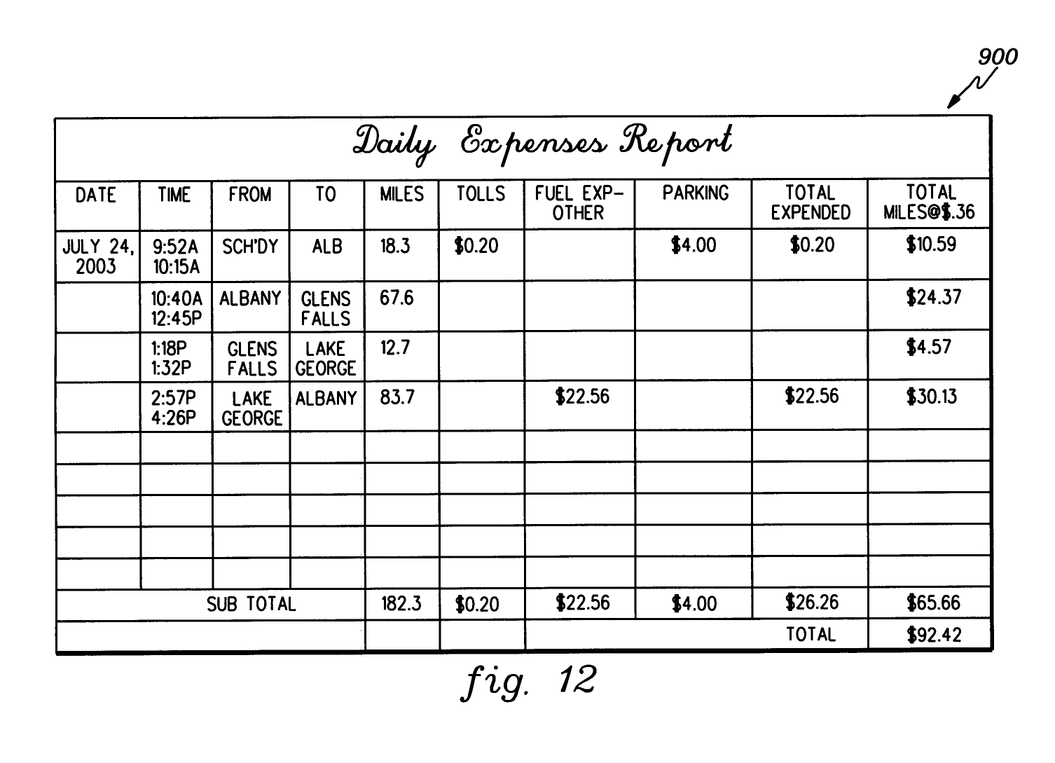

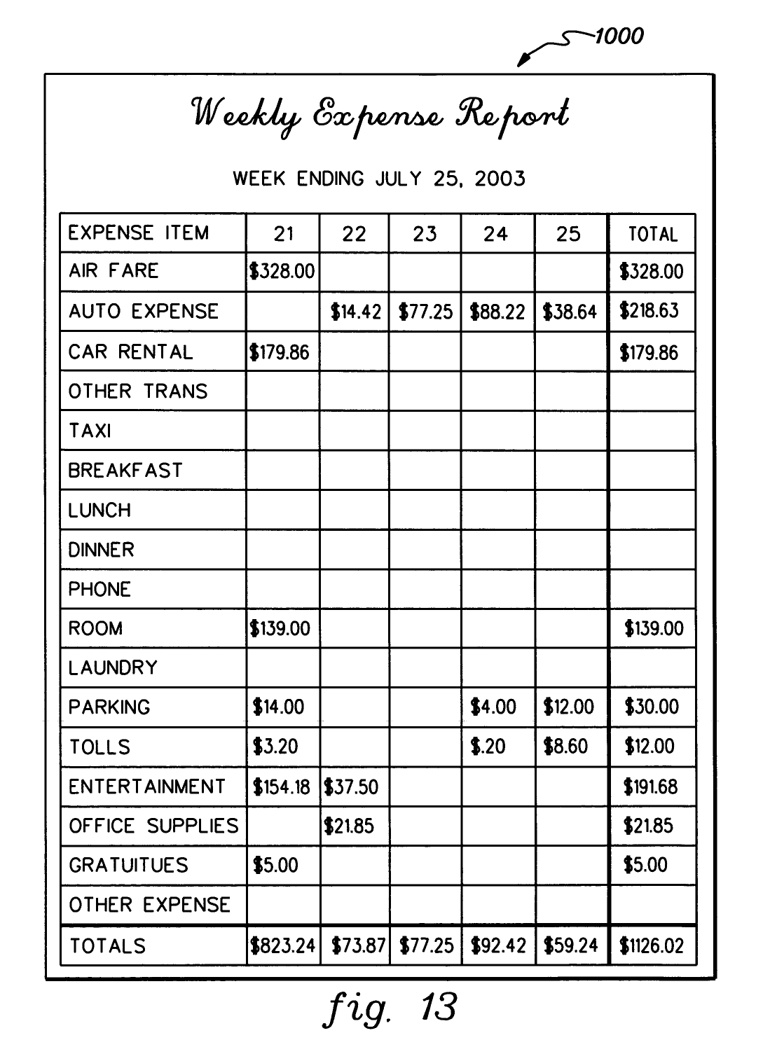

FIG. 12 illustrates an example of a daily expense report 900 for the appointments for a day. Additional categories may include airfare, car rental, meals, etc. FIG. 13 illustrates an example of an expense report for a week. The system may annotate the expense, including date, time and particulars of individuals that the user met with, automatically by extracting the necessary information from the user's calendar entries.

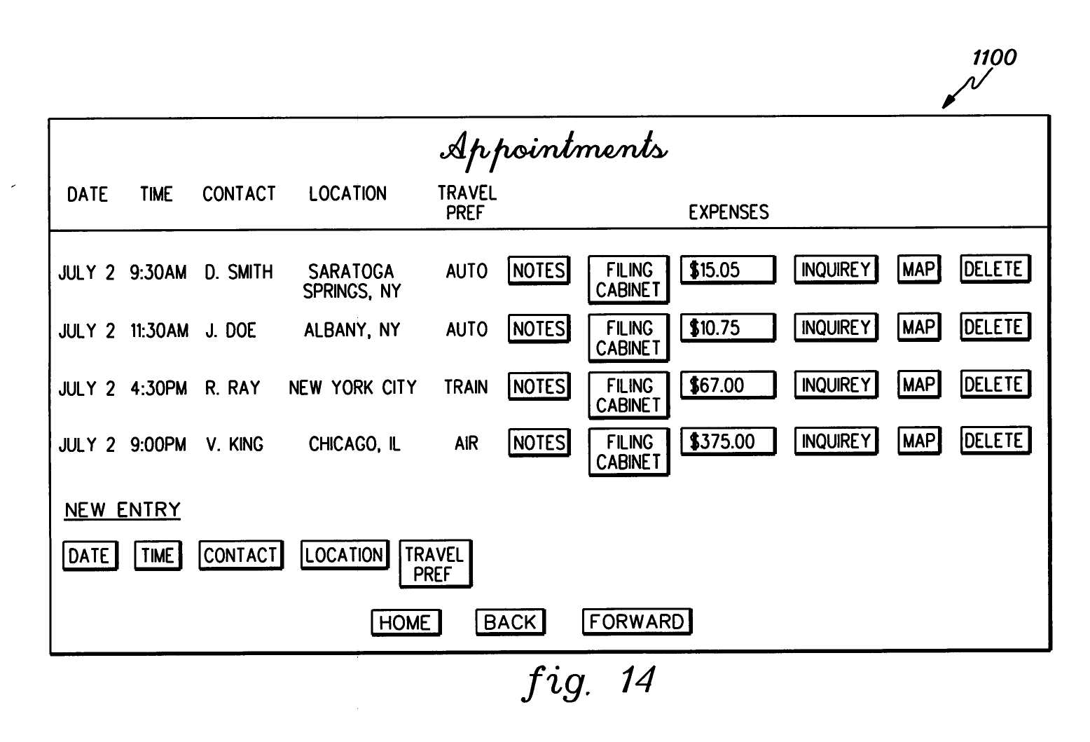

FIG. 14 illustrates another embodiment of an appointments screen 1100 which may be accessed by touching TODAY's APPT button 214 (FIG. 5). Appointment screen 1100 is similar to appointment screen 300 (FIG. 6) with the exception that the expenses may be automatically linked and displayed under an expense column for each of the appointments. Touching the expense amount may allow access and display of the daily expense report, e.g., as shown in FIG. 12.

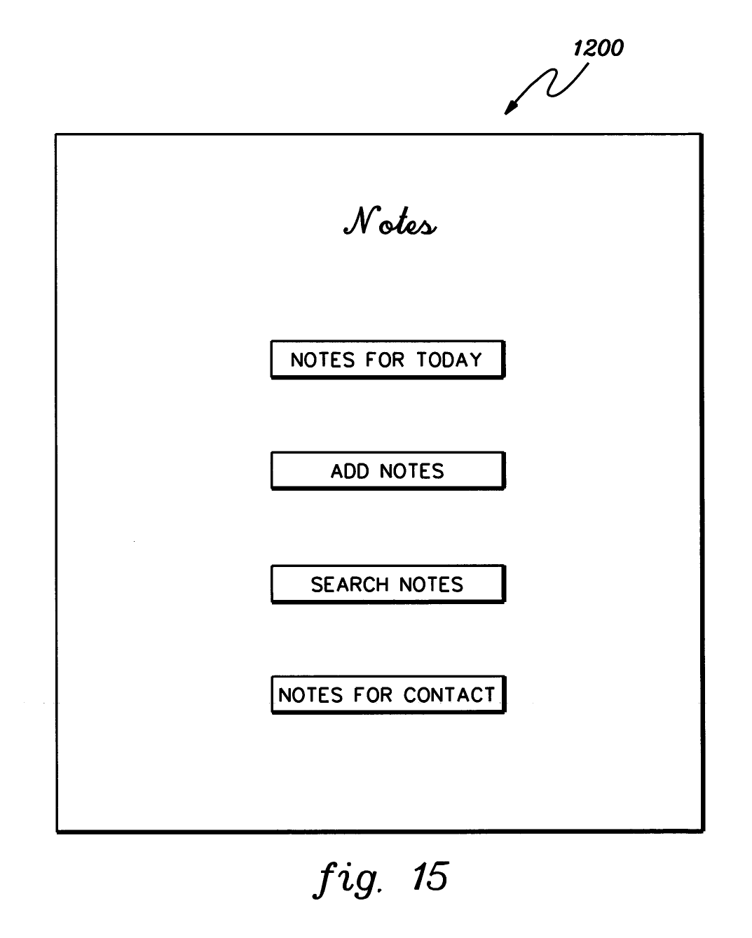

With reference again to FIG. 6, the appointments display may include a plurality of NOTES buttons for retrieving or adding notes relating to particular appointments. Notes may also be accessed via the main menu display screen 200 (FIG. 5) via NOTES button 240 (FIG. 5). FIG. 15 illustrates a NOTES screen 1200 for notes accessed by touching NOTES button 240 (FIG. 5) on main menu display 200 (FIG. 5). Various buttons may be provided for allowing a user to access notes for today, adding notes such as generic notes (e.g., call contact person to confirm upcoming appointment or schedule new appointment) related to a particular day and not related to a particular appointment, search notes, and access notes for contacts.

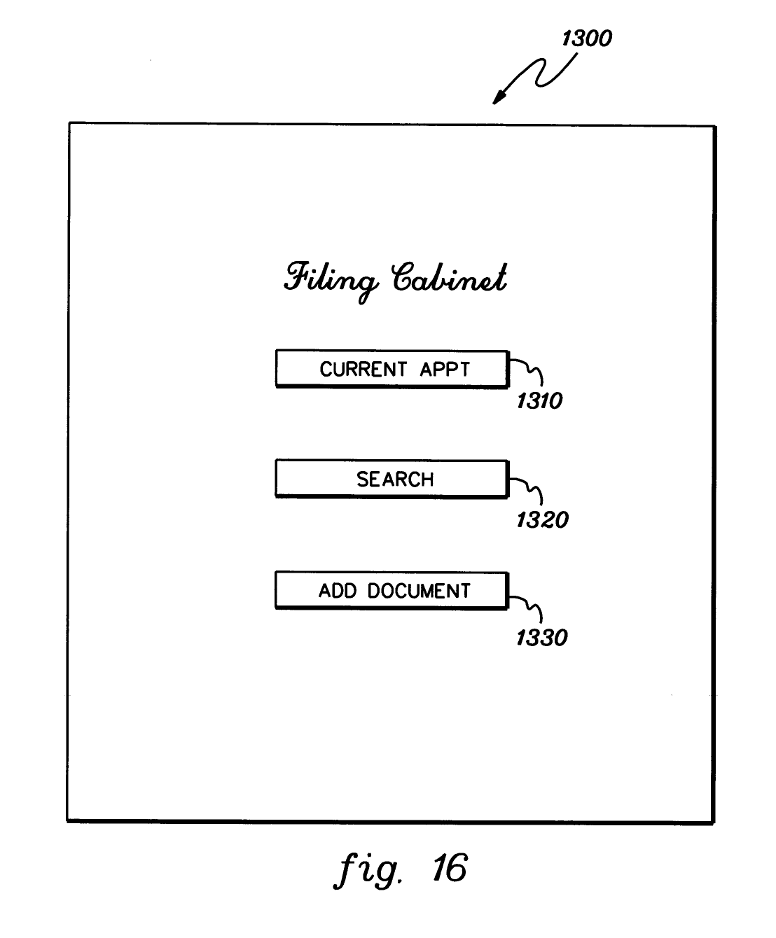

With reference again to FIG. 6, the appointments screen may include FILING CABINET buttons for retrieving or adding documents such as manuals, catalogs, pictures, schematics, and/or text, for the particular appointment. Documents may also be accessed via the main menu display screen 200 (FIG. 5) via button 250 (FIG. 5). FIG. 16 illustrates a filing cabinet screen 1300 accessed by touching FILING CABINET button 250 (FIG. 5) on main menu screen 200 (FIG. 5) and which includes the following buttons a CURRENT APPT button 1310 for retrieving documents relating to the current appointment, a SEARCH button 1320 for searching for particular documents, and an ADD DOCUMENT button 1330 for adding documents. The documents may be stored on the handheld device or stored on the central computing unit or business computer. The handheld device may be connectable to a printer allowing the various documents and other material to be printed out. The handheld device may also have a scanner for scanning and storing or transmitting to the central computing unit or to the business computer the documents scanned.

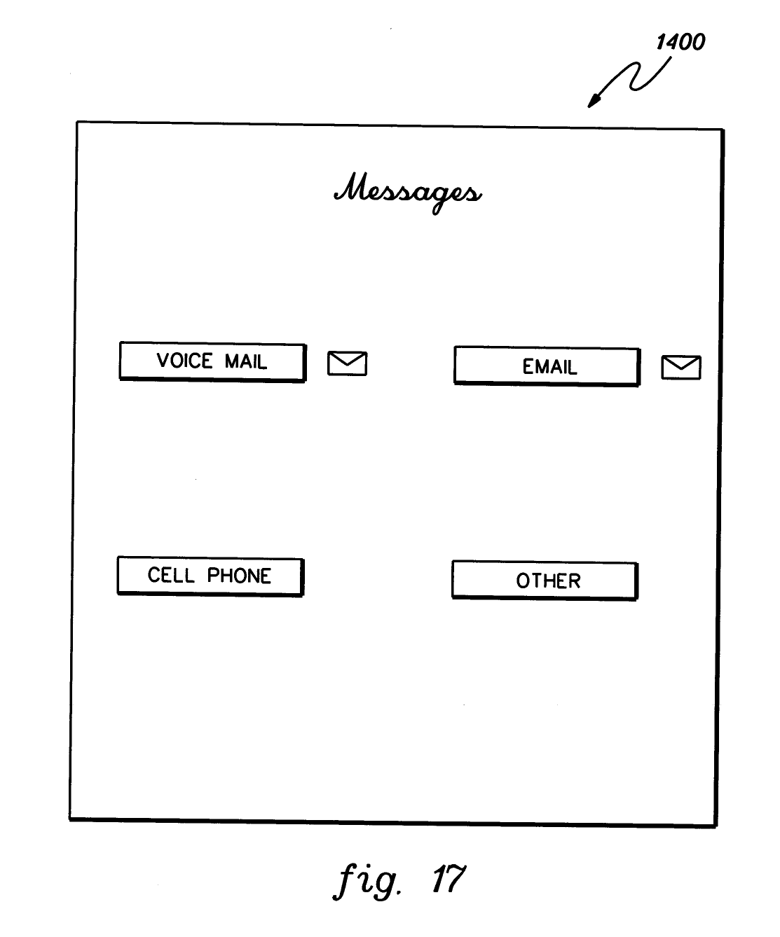

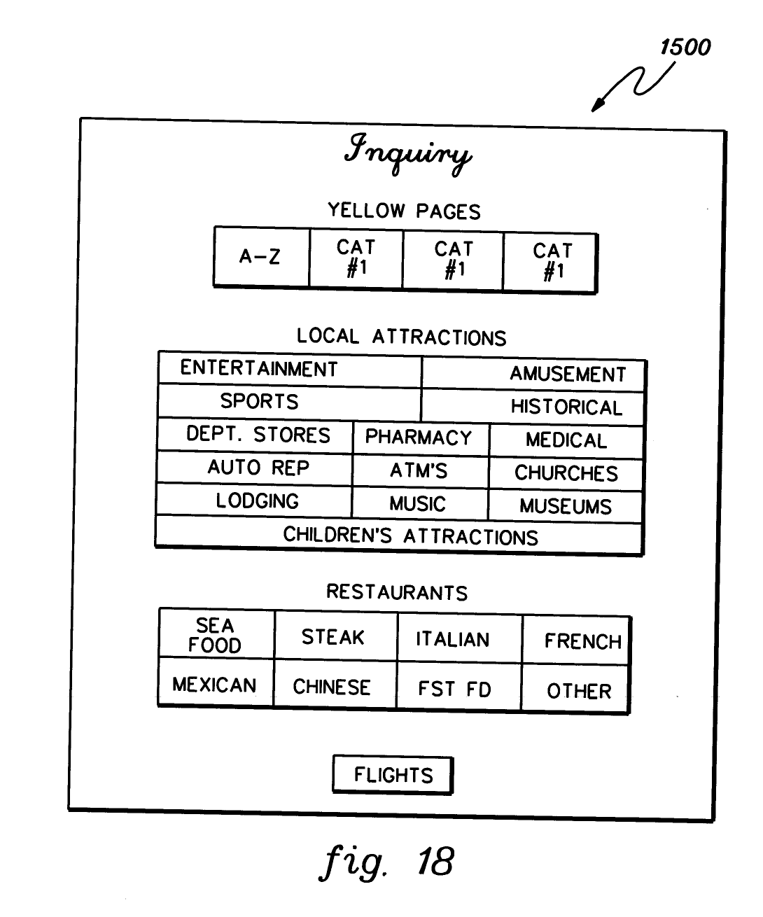

With reference again to FIG. 5, touching MESSAGES button 260 on the main menu screen provides a message screen 1400, as shown in FIG. 17, which allows accessing voice mail messages, email messages, cell phone messages, and other messages. The messages may be forwarded to the handheld device or may be retrieved from various remote locations by the handheld device. Should a message be forwarded or if a message is available to be retrieved, an indicator such as an envelope icon may be displayed to notify the user of a message.

The system links region-specific information from the Internet or other relevant databases, such as a yellow pages database, and directs the information to users situated near the region-specific areas. As shown in FIG. 18, for example, an inquiry screen 1500 may provide a user with access to a yellow pages directory, local attractions, restaurants, and flights. INQUIRY button 345 (FIG. 6) shown on appointment display 300 (FIG. 6) also allows a user to view inquiry screen 1500 and to request and receive information based on the user's appointment location, e.g., find a restaurant near the contact's location for the appointment. INQUIRY button 270 (FIG. 5) on main menu screen 200 (FIG. 5) allows a user to view inquiry screen 1500 and to request and receive information based on the user's current location.

Local attractions may be presented by categories and include children's attractions, museums, music, etc. Once a category has been selected a screen display of a map showing the current location of the user, and location of selected attractions relative to user location may be displayed. Touching the various selections or attractions may provide advertisements detailing specifics relative to the selected attraction. While a fee may be charged to the advertisers for the advertising, some ads may be placed on the database at no charge to the advertisers, such as churches and museums.

Restaurants may be categorized by presenting a variety of restaurant types. Once a restaurant type is selected a display of a map with the locations of those restaurant types in relation to the user's current location may be displayed. Additional features may include the user being able to retrieve and view a restaurant's menu, inquire as to the current waiting time at that particular restaurant, book a reservation, indicate the number of persons in the group, and request preferences such as a non-smoking area, etc.

The system will also use push technology to direct information, such as subscriber listed advertisements, to the user. The information pushed may be demographically based as well as geographically based. The ads may be updated by advertisers at any time, for example to offer daily specials or to make time targeted ads such as advertising lunch specials at lunch time and dinner specials at dinner time. Advertisers may be able to program daily attractions, such as entertainment scheduled for that day. The subscriber service may automatically create a customer database for the benefit of advertisers, including, for example, a record of queries, transactions, customer names and demographics. Advertisers may be able to access the database, for example, to quantify the effectiveness of their advertising.

The inquiry features of the system may be user programmable to certain yellow pages categories (e.g., CAT#1, CAT#2, and CAT#3) of interest to the user, e.g., hospitals, schools, manufactures, banks, etc. Upon the user inquiry, results of the inquiry may be displayed as a map utilizing the user's current location. Mileage radius parameter may also allow the user to expand or contract the contacts presented due to too large or too few number of responses presented.

In addition, a sales prospecting feature may be provided which automatically sets up a series of appointments in the calendar component of the system based on the categories (e.g., selected yellow pages categories CAT#1, CAT#2, and CAT#3) and provides the user with the most efficient routing from the user's then current location or home residence to the various appointments. For example, if a user has a day without any appointments, the user can quickly set up a schedule of various appointment (e.g., new potential contacts or businesses to visit) which may be transferred to the calendar component of the system and set up as daily appointments, or for the purpose of making “cold calls” (e.g., no-pre-scheduled appointment sales calls). This feature may include a “most efficient routing” wherein a point-to-point map may be generated and presented which follows the shortest route between the listed addresses. A notes button may be provided next to each address for the purpose of entering any pertinent information to provide a reminder required for future review.

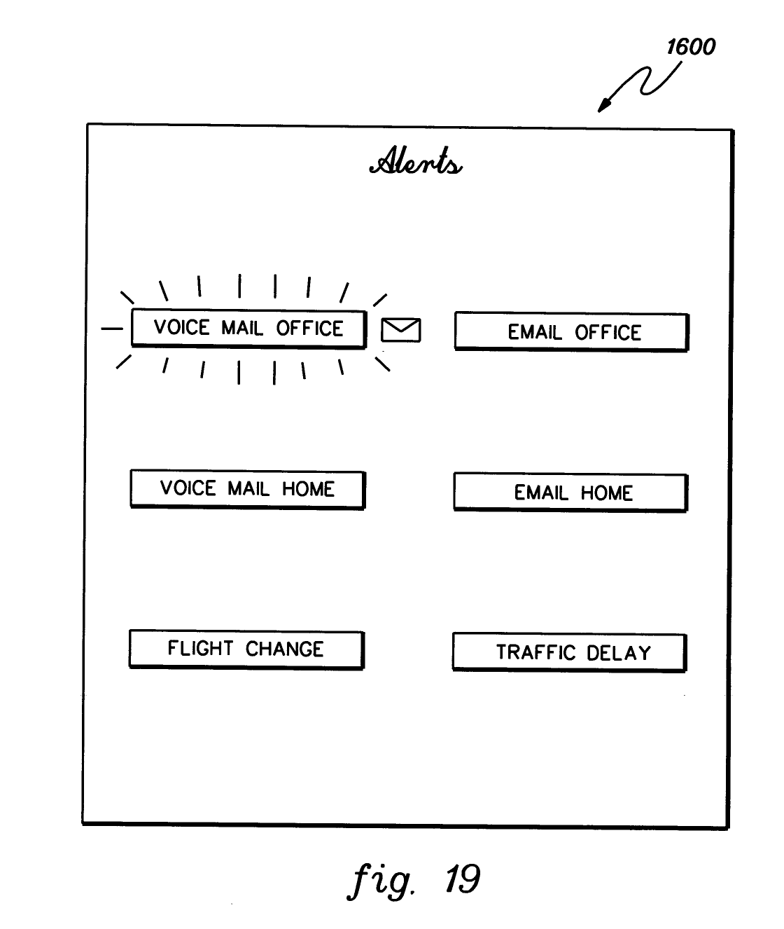

With reference again to the main menu screen 200 of FIG. 5, ALERTS button 280 may be made to flash (or may be displayed as a different color such as the color red) when the user needs to be made aware of a changing situation, or other urgent matter. Touching the ALERTS button may bring up an alerts screen 1600 as shown in FIG. 19. The system may also allow those authorized (office, family, etc.) the ability to contact the user immediately via voice mail or email. A warning sound such as a beep may also be used to notify the user of an alert matter.

The system may also monitor flight status in realtime, and alert the user if a booked flight is delayed or canceled and alert the user of other transportation interruptions. If a booked flight becomes canceled, the system may alert the user, and present alternative flights. If there are no other flights available to the particularly airport (e.g., if the airport is closed), the system may present an alternative means of transportation (e.g., train) and appropriate schedules. The system may allow penalties to be waived when the user agrees to re-book with the airline for substitute arrangements.

The system may be linked to the pertinent motor vehicle department and alerts may also include traffic delays and the system may provide alternative directions to the user.

Alerts may also operate to warn the user of notes to bring up during an appointment. When a note is stored for a particular appointment, the alerts may be configured to alert the user of the note (e.g., offer special, etc.) and when the user presses the alerts button, the notes screen will appear.

Another benefit of the system is that it allows businesses using the system to monitor and locate personnel at all times. Thus, the most appropriate personnel may be contacted through the alert feature to respond to emergencies, i.e., to attend to an urgent service call. In addition, the system, by tracking the location of the user (sending information regarding location to the home office at designated intervals), can send warnings to a business manager when a user is not reporting to a scheduled meeting.

The itineraries and appointments may be archived and accessed by the system the next time an appointment is made to the same or proximate geographic location. For example, the data regarding meetings may be archived in a database, including date, time and location of meetings held, contacts, subject matter notes, and follow-up notes. The archived information will be integrated with any follow-up appointments logged into the calendar.

With sufficient users, the system may monitor multiple users on a given thoroughfare, compute average miles per hour for those users, and if there is a significant slowing of traffic on that thoroughfare, alert other users that are scheduled to travel in that direction. As noted above, the system may provide directions for detours around a traffic jam should the traffic ahead come to a halt.

The system may allow a direct link, e.g., a corporation to create groups of users that are continuously connected. For example persons within the sales department or service department may be connected to one another, or connected only with the manger of that department. Another example may be those listed in the executive management portion of an enterprise having immediate access to others on the executive management team.

The present invention may be configured as a product, service, or a combination thereof that provides unique capabilities to business travelers as well as leisure travelers, worldwide. For example, the system may be provided by a service company which provides the capabilities as a subscription service which may be made available to businesses on a yearly, monthly, or other basis. With regard to leisure travelers, the service may be provided to customers, for example, by car rental companies. In addition, the system may be suitably purchased or rented by leisure travelers when traveling on vacation. The system may also provide security for users in the event of a breakdown, or emergency. For example, the system may allow reporting emergencies including the user's exact location.

In addition, the system and service may be incorporated into cell phones, or the handheld device may incorporate a cell phone, allowing a user to have the capabilities of the present invention along with the capabilities of the cell phone.

The present invention can be included, for example, in an article of manufacture (e.g., one or more computer program products) having, for instance, computer usable media. This media may have embodied therein, for instance, computer readable program code means for providing and facilitating the capabilities of the present invention. The articles of manufacture can be included as part of the computer system or sold separately.

Additionally, at least one program storage device readable by machine, tangibly embodying at least one program of instructions executable by the machine, to perform the capabilities of the present invention, can be provided.

The block diagrams and flowcharts depicted herein are provided by way of example. There may be variations to these diagrams or the steps (or operations) described herein without departing from the spirit of the invention. For instance, in certain cases, the steps may be performed in differing order, or steps or modules may be added, deleted, combined, or modified. All of these variations are considered to comprise part of the present invention as recited in the appended claims.

Thus, while various embodiments of the present invention have been illustrated and described, it will be appreciated by those skilled in the art that many changes and modifications may be made thereunto without departing from the spirit and scope of the invention.

1. A computerized method for determining expenses related to travel, the method comprising:
storing a plurality of appointments at a plurality of different locations;
tracking a physical location of a user in realtime to the plurality of appointments; and
automatically assigning expenses to at least one of the plurality of appointments based on the tracking of the physical location of the user to the plurality of different locations.

2. The computerized method of claim 1 wherein the automatically assigning expenses comprises comparing the location of the user to the plurality of different locations.

3. The computerized method of claim 1 wherein the automatically assigning expenses comprises determining a number of miles traveled by the user between the plurality of different locations.

4. The computerized method of claim 1 further comprising displaying the plurality of appointments and the expenses associated with the plurality of appointments.

5. The computerized method of claim 1 further comprising generating a report of the plurality of appointments and expenses associated with the plurality of appointments.

6. The computerized method of claim 1 wherein the automatically assigning expenses comprises assigning a cost of at least one of an airplane ticket and a train ticket to one of the plurality of appointments.

7. The computerized method of claim 6 wherein the assigning the cost of at least one of an airplane ticket and a train ticket comprises comparing at least one of the arrival and departure locations to the different locations of the appointments.

8. The computerized method of claim 1 wherein the assigning expenses comprises assigning at least one credit card purchase expense to the plurality of appointments.

9. The computerized method of claim 8 wherein the assigning at least one credit card purchase expense comprises comparing at least one of the location and the time of the credit card purchase to a time and a location of the plurality of appointments.

10. The computerized method of claim 1 further comprising manually assigning expenses to the plurality of appointments.

11. The computerized method of claim 1 further comprising storing a plurality of contact profiles comprising at least a name and a location of the contact, and automatically assigning the location of the appointment as the location of the contact.

12. The computerized method of claim 1 wherein the storing further comprises determining a mode of transportation to at least one of the plurality of appointments based on the location of the contact, and wherein the automatically assigning expenses is based on the mode of transportation.

13. The computerized method of claim 1 further comprising storing at least one note and document relating to the appointment.

14. The computerized method of claim 1 further comprising notifying the user of at least one of a message and a warning.

15. The computerized method of claim 1 further comprising providing information to the user based on the physical location of the user.

16. The computerized method of claim 1 further comprising automatically scheduling a plurality of appointments based on a yellow pages directory category.

17. The computerized method of claim 1 wherein the storing, the tracking, and the automatically assigning expenses is performed on a portable device.

18. The computerized method of claim 1 wherein the storing, the tracking, and the automatically assigning expenses is performed on at least one of a handheld device, a laptop computer, and a cell phone.

19. A computerized method for determining expenses related to travel, the method comprising:
storing a plurality of appointments at a plurality of different locations;
tracking a physical location of a user in realtime to the plurality of appointments;
automatically assigning expenses to at least one of the plurality of appointments based on the tracking of the physical location of the user to the plurality of different locations;
automatically assigning expenses regarding at least one of an airplane ticket and a train ticket to at least one of the plurality of appointments;
automatically assigning expenses regarding a purchase to at least one of the plurality of appointments; and
at least one of displaying and printing a report of the plurality of appointments and the expenses associated with the plurality of appointments.

20. A computerized method for assisting a traveler, the method comprising:
storing a plurality of contact profiles comprising at least a name and a location of the contact,
storing a plurality of appointments at a plurality of different locations, the storing comprising automatically assigning at least one location of the contact as the location of the appointment;
tracking a physical location of a user in realtime to the plurality of appointments;
automatically assigning expenses to at least one of the plurality of appointments based on the tracking of the physical location of the user to the plurality of different locations;
storing at least one note and document relating to at least one of the appointments;
notifying the user of at least one of a message and a warning; and
providing information to the user relating to the physical location of the user.

21. The computerized method of claim 20 further comprising determining a mode of transportation to at least one of the plurality of appointments based on the location of the contact in the client profiles, and wherein the automatically assigning expenses is based on the mode of transportation.

22. A portable electronic device for determining expenses related to travel for a user, the device comprising:
a processor;
a position locating device, a memory, an input device, and a display, and a wireless transmitter operably connected to said processor; and
wherein said processor is operable to store a plurality of appointments having a plurality of different locations, track a physical location of a user in realtime to the plurality of appointments based on data from the position locating device, automatically assign expenses to at least one of the plurality of appointments based on the tracking of the physical location of the user to the plurality of different locations.

23. The portable electronic device of claim 22 wherein said processor is operable to display on said display at least one of the plurality of appointments and the expenses automatically assigned thereto.

24. The portable electronic device of claim 22 wherein said processor is operable to display on said display a report of the expenses.

25. A portable electronic device for determining expenses related to travel for a user, the device comprising:
a processor;
a position locating device, a memory, an input device, and a display, and a wireless transmitter operably connected to said processor; and
wherein said processor is operable to store a plurality of appointments at a plurality of different locations, track a physical location of a user in realtime to the plurality of appointments based on data from the position locating device, automatically assign expenses to at least one of the plurality of appointments based on the tracking of the physical location of the user to the plurality of different locations, automatically assign expenses regarding at least one of an airplane ticket and a train ticket to at least one of the plurality of appointments, automatically assign expenses regarding a purchase to at least one of the plurality of appointments, and at least one of display and print a report of the plurality of appointments and the expenses associated with the plurality of appointments.

26. A portable electronic device for determining expenses related to travel for a user, the device comprising:
a processor;
a position locating device, a memory, an input device, and a display, and a wireless transmitter operably connected to said processor; and
wherein said processor is operable to store a plurality of contact profiles comprising at least a name and a location of the contact, store a plurality of appointments at a plurality of different locations, said storing comprising automatically assigning at least one location of the contact as the location of the appointment, track a physical location of a user in realtime to the plurality of appointments based on data from said position locating device, automatically assign expenses to at least one of the plurality of appointments based on the tracking of the physical location of the user to the plurality of different locations, store at least one note and document relating to at least one of the appointments, notify the user of at least one of a message and a warning, and provide information to the user relating to the physical location of the user.

27. The portable electronic device of claim 26 wherein said processor is operable to display on said display at least one of the plurality of appointments and the expenses automatically assigned thereto.

28. The portable electronic device of claim 26 wherein said processor is operable to display on said display a report of the expenses.

29. A system for determining travel expenses, the system comprising:
means for storing a plurality of appointments at a plurality of different locations;
means for tracking a physical location of a user in realtime to the plurality of appointments; and
means for automatically assigning expenses to at least one of the plurality of appointments based on the tracking of the physical location of the user to the plurality of different locations.

30. A system for determining travel expenses, the system comprising:
means for storing a plurality of appointments at a plurality of different locations;
means for tracking a physical location of a user in realtime to the plurality of appointments;
means for automatically assigning expenses to at least one of the plurality of appointments based on the tracking of the physical location of the user to the plurality of different locations;
means for automatically assigning expenses regarding at least one of an airplane ticket and a train ticket to at least one of the plurality of appointments;
means for automatically assigning expenses regarding a purchase to at least one of the plurality of appointments; and
at least one of means for displaying and means for printing a report of the plurality of appointments and the expenses associated with the plurality of appointments.

31. A system for determining travel expenses, the system comprising:
means for storing a plurality of contact profiles comprising at least a name and a location of the contact,
means for storing a plurality of appointments at a plurality of different locations, said storing comprising automatically assigning at least one location of the contact as the location of the appointment;
means for tracking a physical location of a user in realtime to the plurality of appointments;
means for automatically assigning expenses to at least one of the plurality of appointments based on the tracking of the physical location of the user to the plurality of different locations;
means for storing at least one note and document relating to the appointment;
means for notifying the user of at least one of a message and a warning; and
means for providing information to the user based on the physical location of the user.

32. A method for providing a service to a business for determining expenses relating to travel to plurality of appointments for a plurality of employees, the method comprising:
providing a plurality of handheld devices of claim 22 to the plurality of employees;
providing a central computing unit;
receiving data at the central computing unit regarding physical locations of the plurality of employees and expenses automatically assigned to the plurality of appointments via a communications network from the plurality of handheld devices; and
transferring the data from the central computing unit to a business computer via a communications network.

33. The method of claim 32 further comprising receiving data regarding purchases by the employees, and assigning the purchases to the appointments.

34. The method of claim 32 further comprising receiving data regarding booked travel arrangements by the employees, and assigning the purchases to the appointments.

35. The method of claim 32 further comprising transferring data to the users regarding changes in a scheduled mode of transportation.

36. The method of claim 35 further comprising transferring data to the users regarding alternative modes of transportation to an appointment.

37. A method for providing a service to a business for determining expenses relating to travel to plurality of appointments for a plurality of employees, the method comprising:
providing a plurality of handheld devices of claim 25 to the plurality of employees;
providing a central computing unit;
receiving data at the central computing unit regarding physical locations of the plurality of employees and expenses automatically assigned to the plurality of appointments via a communications network from the plurality of handheld devices;
receiving data regarding purchases by the employees, and automatically assigning the expenses for the purchases to the appointments;
receiving data regarding booked travel arrangements by the employees, and automatically assigning the expenses for purchases to the appointments; and
transferring the data from the central computing unit to a business computer via a communications network.

38. At least one program storage device readable by a machine tangibly embodying at least one program of instructions executable by the machine to perform a method for determining expenses related to travel, comprising:
storing a plurality of appointments at a plurality of different locations;
tracking a physical location of a user in realtime to the plurality of appointments; and
automatically assigning expenses to at least one of the plurality of appointments based on the tracking of the physical location of the user to the plurality of different locations.

39. At least one program storage device readable by a machine tangibly embodying at least one program of instructions executable by the machine to perform a method for providing a service to a business for determining expenses relating to travel to a plurality of appointments for a plurality of employees, the method comprising:
receiving data at the central computing unit regarding physical locations of the plurality of employees and expenses automatically assigned to the plurality of appointments via a communications network from a plurality of handheld devices; and
transferring the data from the central computing unit to a business computer via a communications network.
